(19) United States
(12) Patent Application Publication
(10) Pub. No.: US 2021/0365606 A1
(43) Pub. Date: Nov. 25, 2021

(54) QUANTUM COMPUTING METHOD FOR EXPRESSWAY TRAFFIC FLOW DISTRIBUTION SIMULATION CONSIDERING DESTINATION SELECTION

(71) Applicant: NANJING NORMAL UNIVERSITY, Jiangsu (CN)

(72) Inventors: Zhaoyuan YU, Jiangsu (CN); Xinxin ZHOU, Jiangsu (CN); Hong GAO, Jiangsu (CN); Chunye ZHOU, Jiangsu (CN); Xu HU, Jiangsu (CN)

(73) Assignee: NANJING NORMAL UNIVERSITY, Jiangsu (CN)

(21) Appl. No.: 17/252,738

(22) PCT Filed: Jun. 12, 2020
(86) PCT No.: PCT/CN2020/095769

§ 371 Date: Dec. 16, 2020

(30) Foreign Application Priority Data
Dec. 9, 2019 (CN) 201911249339.4

(51) Int. Cl. G06F 30/20; G06N 10/00; G06Q 50/30

(52) U.S. Cl. CPC G06F 30/20; G06F 2111/08; G06Q 50/30; G06N 10/00

(57) ABSTRACT

The present invention discloses a quantum computing method for expressway traffic flow distribution simulation considering destination selection. The method comprises the following steps. (1) Construct an expressway exit and entrance network structure. (2) Use a complex number to represent direction-and-flow superposition states of vehicles. (3) Construct a model and setting parameters. (4) Simulate a quantum random walk. (5) Perform model check and time-space matching. and (6) Fit and compare the quantum random walk with real flow data. The present invention can simulate the characteristics of quasi-periodic oscillation and irregularity in expressway traffic flow, closely integrate traffic observation data and reveal the deep characteristics of traffic behavior from a new perspective, thus increasing the accuracy and efficiency of expressway traffic flow simulation.

### TECHNICAL FIELD

The present invention relates to the technical field of computer graphics, and in particular to a quantum computing method for expressway traffic flow distribution simulation considering destination selection.

### BACKGROUND

Intercity expressways can effectively connect cities and promote economic exchange. Traffic flow is characterized by uneven speed distribution, specifically high traffic density and nonlinear complexity (such as coherence) between vehicles. In expressway traffic flow, the small change of personal driving behavior will be quickly transmitted by the vehicle, and will have a massive impact on the traffic flow. The comprehensive impact of a large number of personal driving behaviors makes the overall traffic flow exhibit obvious dispersion and nonlinearity in time and space. A stochastic simulation model provides the potential to associate macroscopic traffic flow states with the uncertainty of a single driver's decision. However, due to the limit of observation data, modeling mechanism and computing complexity, there are still some difficulties in simulating macroscopic and microscopic expressway traffic flow.

A stochastic simulation method for expressway traffic flow can be classified into four categories: simulation based on a classical statistical model, simulation based on a statistical physical model, simulation based on a state-space model and simulation based on an intelligent agent model. A simulation method based on the classical statistical model regards expressway traffic flow as a random process, and simulates the evolution of the process by modeling its distribution and changing process. It usually assumes that traffic flow is in a stable or balanced state, which limits the adaptability of such a simulation method. A simulation method based on the statistical physical model simulates different scales of expressway traffic flows through particle interaction. Although this method has a clear physical mechanism and can be effectively solved numerically, it usually ignores individual behavior heterogeneity. A simulation method based on the state-space model assumes that traffic flow has multiple states with different characteristics, and attempts to estimate the different states in the traffic flow, and it can be well integrated with the observational data. However, most of simulation methods based on the state-space model have complex steps and parameters, and require high-quality data and fine model adjustment. A simulation method based on the intelligent agent model simulates traffic flow through the interaction of agents to achieve stochastic simulation. Such a method usually has very high computing complexity and sensitivity to parameter, and therefore cannot simulate long-distance expressway traffic flows among multiple cities.

The aforementioned expressway traffic simulation method seldom considers the uncertain impact of drivers' subjective decisions on overall traffic flow. Due to the characteristics of high speed and high density of expressway traffic, the randomness of traffic dynamics will lead to vehicle heterogeneity. A study shows that attention should be paid to driver perception uncertainty, because it will further affect the state of overall traffic flow, particularly expressway traffic flow. However, there is no such a related technology that integrates such uncertainty in the traffic simulation model.

### SUMMARY

The technical problem to be solved by the present invention is to provide a quantum computing method for expressway traffic flow distribution simulation considering destination selection, which can simulate the characteristics of quasi-periodic oscillation and irregularity in expressway traffic flow, closely integrate big data of behavior observation and reveal the deep characteristics of traffic behavior from a new perspective, thus increasing the accuracy and efficiency of expressway traffic flow simulation.

In order to solve the aforementioned technical problem, the present invention provides a quantum computing method for expressway traffic flow distribution simulation considering destination selection, comprising the following steps.

(1) Construct an expressway exit and entrance network structure.

(2) Use a complex number to represent direction-and-flow superposition states of vehicles.

(3) Construct a model and setting parameters.

(4) Simulate a quantum random walk.

(5) Perform model check and time-space matching.

(6) Fitting and comparing the quantum random walk with real flow data.

Preferably, constructing an expressway exit and entrance network structure in step (1) comprises: an unweighted, undirected and acyclic network graph G=(V, E) is created according to the connecting relation between an expressway network and stations extracted from expressway network data to be simulated, wherein V represents a vertex set of G, E represents an edge set of G; and an adjacency matrix of the network graph and its eigenvalues, eigenvectors and eigenprojections are calculated.

Preferably, using a complex number to represent direction-and-flow superposition states of vehicles in step (2) comprises: a quantum model is used to make each vehicle in a superposition state of simultaneously existing from each exit; dynamic probabilities are used to characterize and explain such a superposition state; a mapping parameter between the model in the present invention and actual situation is calculated according to walk time and the eigenvalues of the network graph; and a probability amplitude matrix for each vertex, i.e., a wave function, is obtained based on the mapping parameter and combining with the eigenprojections.

Preferably, constructing a model and setting parameters in step (3) comprises: assuming that a walker is in a state |ν [symbol] at the initial time, the continuous quantum walk state of the walker on G is a linear superposition state for all ground states at any time t in quantum mechanics, i.e.,

|φ(t) [symbol] =Σ_{νϵV}α_{ν}(t)|ν [symbol] (1)

wherein v is a vertex, V is a vertex set of G, α_{ν}(t) is a probability amplitude of a corresponding ground state |ν [symbol] at a time t, and |α_{ν}(t)|ϵ[0,1]; and the probability of the random walker in a ground state |ν [symbol] at a time t is p(|ν [symbol] ), t)=α_{ν}(t)α*_{ν}(t), wherein α*_{ν}(t) is a complex conjugate of α_{ν}(t), and at any time t, Σ_{νϵV}, p(|ν [symbol] , t)=1 is met.

The state of the walker after time t can be obtained by the following equation:

|φ(t) [symbol] =e^{-iAt}|ν [symbol] (2)

wherein e^{-iAt} is a computing operator of an adjacency matrix A.

The probability p_{νu}(t) of the walker walking from the vertex v to the vertex u after time t is:

p_{νu}(t)=|u|φ(t) [symbol] ├² (3)

Preferably, simulating a quantum random walk in step (4) comprises: a simulation experiment is carried out based on the quantum random walk model, and is compared with actual direction-and-flow data of walkers on the expressway to continuously optimize the initial state and walk time of the walkers.

Preferably, performing model check and time-space matching in step (5) comprises: an exhaustive search mechanism is used to change the parameter t at a certain interval Δt and find an optimal model parameter; when a certain parameter t is reached with observation data and simulation data having the highest similarity/lowest dissimilarity, there are obvious energy resonances in different time scales, and the parameter is regarded as an optimal parameter for such transportation systems.

The benefits of the present invention are as follows: the present invention can simulate the characteristics of quasi-periodic oscillation and irregularity in expressway traffic flow, closely integrate traffic observation data and reveal the deep characteristics of traffic behavior from a new perspective, thus increasing the accuracy and efficiency of expressway traffic flow simulation.

### BRIEF DESCRIPTION OF THE DRAWINGS

FIG. 1 is a schematic flow chart of a method according to the present invention.

FIG. 2 is a schematic flow chart of a model design according to the present invention.

FIG. 3 is a schematic map of an experimental region according to the present invention.

FIG. 4 is a schematic graph of comparison between observation data and simulation data according to the present invention.

### DETAILED DESCRIPTION

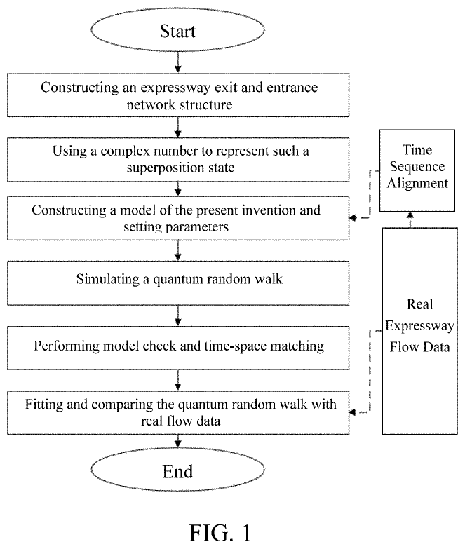

As shown in FIG. 1, a quantum computing method for expressway traffic flow distribution simulation considering destination selection comprises the following steps.

Step 1: construct an expressway exit and entrance network structure. An unweighted, undirected and acyclic network graph G=(V, E) is created according to the connecting relation between an expressway network and stations extracted from expressway network data to be simulated, wherein V represents a vertex set of G, and E represents an edge set of G. An adjacency matrix Aᵤᵥ of the network graph may be represented by:

$${A}_{uv} = \{ \begin{matrix}1 , & if ( u , v ) ∈ E \\ 0 , & otherwise\end{matrix} \qquad ( 4 )$$

The adjacency matrix of the network graph and its eigenvalues, eigenvectors and eigenprojections are calculated.

Step 2: use a complex number to represent such a superposition state. A quantum model is used to make each vehicle in a superposition state of simultaneously existing from each exit, and dynamic probabilities are used to characterize and explain such a superposition state.

Dynamic exit selection performed by different vehicles can be regarded as a random process, so a complex variable with two states (“exiting |a [symbol] ” and “not exiting |b [symbol] ”) can be used for modeling. As some vehicles cannot simultaneously have both states |a [symbol] and |b [symbol] , the two state vectors are orthogonal. However, as every vehicle changes within a certain period of time, there must be certain probability distribution existing in the changes of the states |a [symbol] and |b [symbol] . Therefore, the present invention can formulate one complex number to represent the state of any vehicle:

φₜ=aₜ|a [symbol] +bₜ|b [symbol] i (5)

Calculate a wave function of the present invention: a mapping parameter between the model in the present invention and actual situation is calculated according to walk time and the eigenvalues of the network graph. A probability amplitude matrix for each vertex, i.e., a wave function of the present invention, is obtained based on the mapping parameter and combining with the eigenprojections.

In a quantum mechanism, quantum random walk dynamics controlled by Hamiltonian H may be represented by a time-evolution operator U(t).

U(t)=e^{-iHt} (6)

wherein H may be an adjacency matrix for the expressway network, i.e.,

$$H = [ \begin{matrix}0 & 1 & 0 & … & 0 & 0 \\ 1 & 0 & 0 & … & 0 & 0 \\ 0 & 1 & 0 & … & 0 & 0 \\ ⋮ & ⋮ & ⋮ & ⋱ & ⋮ & ⋮ \\ 0 & 0 & 0 & … & 1 & 0 \\ 0 & 0 & 0 & … & 0 & 1 \\ 0 & 0 & 0 & & 0 & 0\end{matrix} ] \qquad ( 7 )$$

Step 3: construct a model of present invention and setting parameters. The continuous quantum walk state of a walker on G is a linear superposition state for all ground states at any time t in quantum mechanics, i.e.,

|φ(t) [symbol] =Σ_{νϵV}α_{ν}(t)|ν [symbol] (8)

wherein α_{ν}(t) is the probability amplitude of a corresponding ground state |ν [symbol] at a time t, and |α_{ν}(t)|ϵ[0,1]. The probability of the random walker in a ground state |ν [symbol] at a time t is p(|ν [symbol] ,t)=α_{ν}(t) α*_{ν}(t), wherein α*_{ν}(t) is a complex conjugate of α_{ν}(t), and at any time t, Σ_{νϵV}p(|ν [symbol] , t)=1 is met.

Unlike the walk process of classical random walk, the walk process of continuous quantum walk is not a Markov chain. The evolution process of continuous quantum walk's state vector |φ(t) [symbol] over time t is achieved by the following unitary transformation:

$$\frac{d}{dt} \vert φ ( t ) 〉 = iA \vert φ ( t ) 〉 \qquad ( 9 )$$

Assuming that the walker is in the state |ν [symbol] at the initial time, the state of the walker after time t can be obtained by equation (3):

|φ(t) [symbol] =e^{-iAt}|ν [symbol] (10)

The probability p_{νu}(t) of the walker walking from the vertex v to the vertex u after time t is:

p_{νu}(t)=|u|φ(t) [symbol] |² (11)

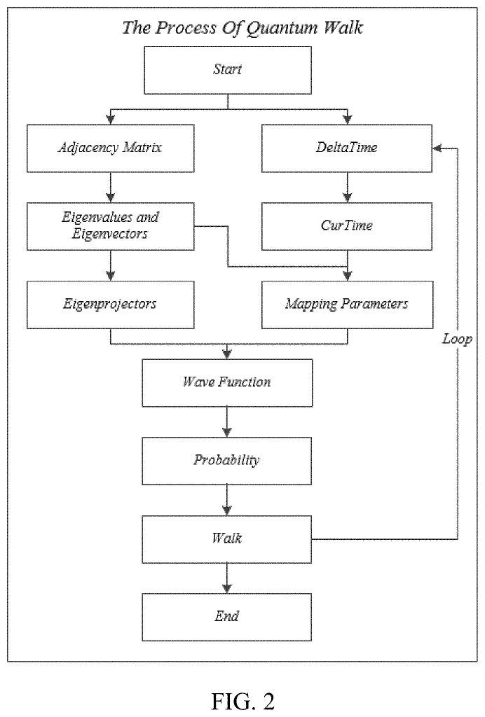

It can be known from equation (10) and equation (11) that under the condition that the initial state of the walker is known, factors which affect the probability of the walker walking from the vertex v to the vertex u are the adjacency matrix (topological structure) of the network graph and walk time. Therefore, the initial state of the walker, the adjacency matrix (topological structure) of the network graph and walk time are key parameters for determining the present invention, and have direct influence on a study result, as shown in FIG. 2.

Step 4: simulate a quantum random walk. A simulation experiment is carried out based on the quantum random walk model, and is compared with actual direction-and-flow data of walkers on the expressway to continuously optimize the initial state and walk time of walkers.

As Hamiltonian H is a matrix and the numerical solution of the model is very complex, the present invention can use polynomial expansion to make QRW from equation (12), the present invention has:

e^{-iHt}=Σₙ₌₀^{N-1}cₙHⁿ (12)

wherein N is the numbers of different eigenvalues of H and cₙ, which are unknown coefficients that must be determined. These coefficients can be determined by using equation (13), and will continue to be effective when each of their eigenvalues is used to replace H. It is assumed that the Tylor expansion of U(t) is:

U(t)=c₀l+c₁H+c₂H²+c₃H³+ . . . +cₙHⁿ (13)

wherein the unit matrix that can be regarded as H⁰ is I, while cᵢ is a weight coefficient to be determined. The evaluation of the time-evolution operator by the present invention is based on the Cayley-Hamilton theorem, pointing out that every square matrix meets its own characteristic equation:

det(A−Iλ)=0 (14)

wherein A is an original matrix, I is a unit matrix, and λ is an eigenvalue. A characteristic equation is a polynomial equation in λ, and the characteristic equation will be kept effective when A is used to replace λ. The present invention can use each eigenvalue in the aforementioned equations to replace Hamiltonian by employing the Cayley-Hamilton theorem, so as to obtain the following equation set:

$$[ \begin{matrix}{e}^{- i {λ}_{1} t} \\ {e}^{- i {λ}_{2} t} \\ ⋮ \\ {e}^{- i {λ}_{n - 1} t} \\ {e}^{- i {λ}_{n} t}\end{matrix} ] = [ \begin{matrix}1 & {λ}_{1} & {λ}_{1}^{2} & … & {λ}_{1}^{n - 1} \\ 1 & {λ}_{2} & {λ}_{2}^{2} & … & {λ}_{2}^{n - 1} \\ ⋮ & ⋮ & ⋱ & … & ⋮ \\ 1 & {λ}_{n - 1} & {λ}_{n - 1}^{2} & … & {λ}_{n - 1}^{n - 1} \\ 1 & {λ}_{n} & {λ}_{n}^{2} & … & {λ}_{n}^{n - 1}\end{matrix} ] [ \begin{matrix}{c}_{0} \\ {c}_{1} \\ ⋮ \\ {c}_{n - 1} \\ {c}_{n}\end{matrix} ] \qquad ( 15 )$$

The coefficients can be solved by simple linear algebra to obtain an expression for the time-evolution operator: n×n matrix.

Step 5: performing model check and time-space matching. For equation (15), it can be known that t affects the right side of e^{-iλ}^{ᵢ}^{t}, wherein t is a scaling factor. The larger or smaller t is, the greater frequency change is. Therefore, the present invention can use the exhaustive search mechanism to change the parameter t at a certain internal Δt, and provides a verification method to find an optimal model parameter. Actual flow has multi-scale changes as affected by a variety of factors, and therefore, it is better to consider both overall similarity and time-frequency power resonance at different smoothing levels. When a certain parameter t is reached with observation data and simulation data have the highest similarity/lowest dissimilarity, there are obvious energy resonances in different time scales, and the parameter is regarded as an optimal parameter for such transportation systems in the present invention. Here, a dissimilarity index (CORT) combining temporal correlation and original value behavior and a cross wavelet spectrum are chosen as similarity measures.

The dissimilarity between original data and simulation data is measured according to the dissimilarity index (CORT) combining temporal correlation and original actual behavior of vehicle flow on the expressway network in selecting exits. CORT measures the proximity between dynamic behaviors x and y through a first-order temporal correlation coefficient defined by the following terms:

$$CORT ( x , y ) = Σ ( {x}_{( t + 1 )} - {x}_{t} ) ( {y}_{( t + 1 )} - {y}_{t} ) / ( \sqrt{( {Σ ( {x}_{( t + 1 )} - {x}_{t} )}^{2} ) \sqrt{( {Σ ( {y}_{( t + 1 )} - {y}_{t} )}^{2} )}} ) \qquad ( 16 )$$

The difference between the time sequences x and y is given by the following equation:

d(x,y)=Φ[CORT(x,y)]δ(x,y) (17)

wherein Φ[u]=2/(1+e^{ku}) is an adaptive adjustment function with k≥0.δ(x, y) represents the Euclidean distance between the original values of the sequences x and y. Both Φ and k modulate the weight d(x, y) of CORT(x, y). The present invention can reveal simulation performance in different time scales by controlling different k of the differential weight between the dynamic behaviors.

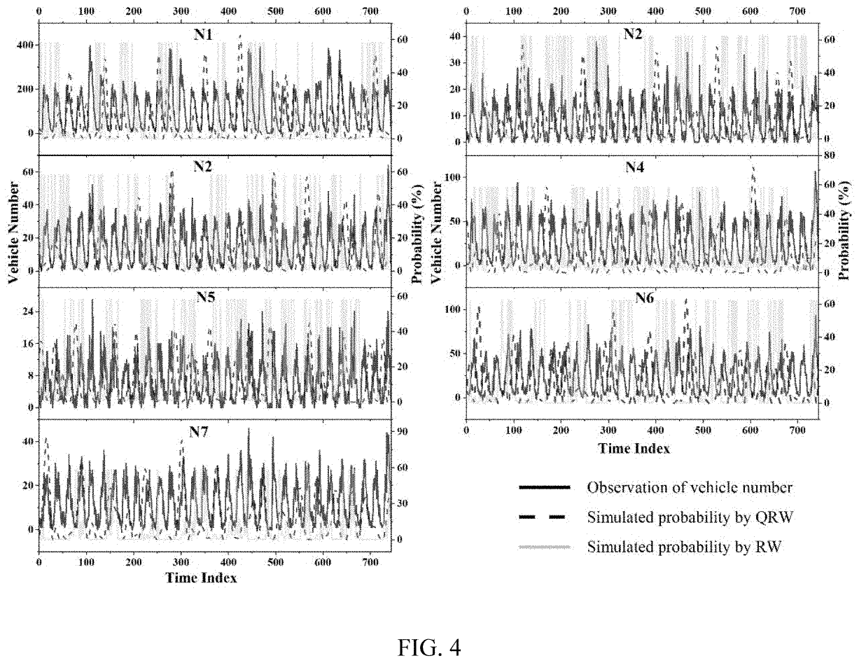

Step 6: fit and compare the quantum random walks with real flow data. For comparison, the present invention also calculates classical random walk (RW) with restart probability r=0.5 on the same graph as a reference. FIG. 4 shows the comparison between observed traffic data and simulation data of RW and quantum random walk.

The meaning of each variable is as follows. G is an unweighted, undirected and acyclic network graph created according to the connecting relation between an expressway network and stations extracted from expressway network data to be simulated. V is a vertex set of G. E is an edge set of G. Aᵤᵥ, is an adjacency matrix of the network graph G. t is any time. The state space of a quantum system is represented by a Hilbert space. A Dirac symbol | [symbol] is introduced to represent a quantum state, and | [symbol] represents a column vector called a ket. |φ(t) [symbol] is a continuous quantum walk state of a walker on G, which is a linear superposition state for all ground states. And |ν [symbol] is a ground state, which is a state in which the walker is at the initial time. α_{ν}(t) is the probability amplitude of the corresponding ground state |ν [symbol] of the walker at a time t. p_{νu}(t) is the probability of the walker walking from the vertex v to the vertex u, wherein v and u are respectively two different vertexes, dynamic exit selection performed by different vehicles can be regarded as a random process. |a [symbol] represents a state of selecting an exit a, and |b [symbol] represents a state of selecting an exit b. And H is Hamiltonian. N is the numbers of different eigenvalues of H and cₙ. A is an original matrix. I is a unit matrix. λ is an eigenvalue. CORT is a dissimilarity index combining temporal correlation and original actual behavior of vehicle flow on the expressway network in selecting exits. And e^{-iAt} is a computing operator of an adjacency matrix A.

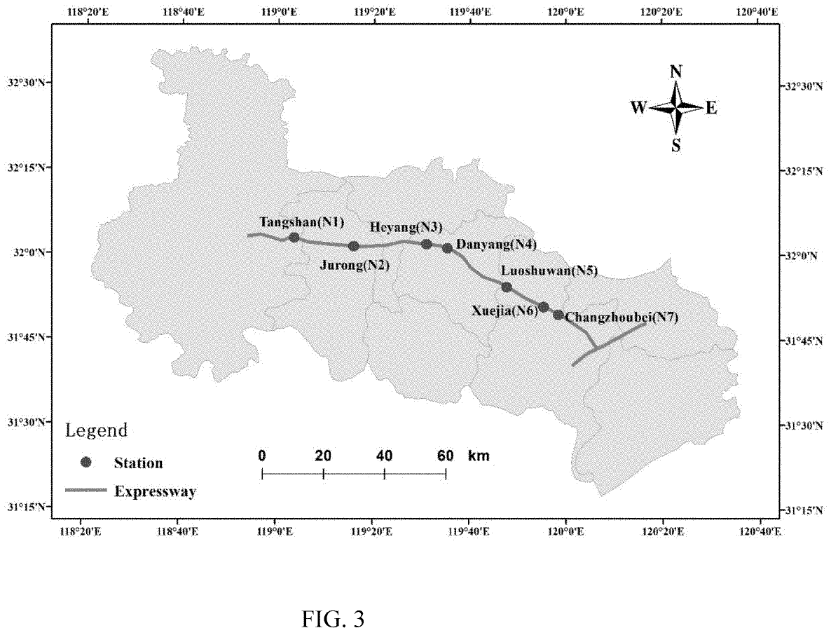

Taking the Nanjing-Changzhou section of the Shanghai-Nanjing expressway as a studied region, the present invention chose the distribution of vehicles departing from Nanjing and passing the toll stations from Dec. 1, 2015 to Dec. 30, 2015. In order to form intercity expressway traffic, the present invention only chose the vehicles directly coming from Nanjing at each toll station. The quantity of original data information recorded when each vehicle passed a toll station was large, and data distribution was highly uneven. Therefore, the present invention standardized the data, and adopted a cumulative vehicle number every other hour. The number of all sampling points was 7 (stations) multiplied by 744 (time points at each station), as shown in FIG. 3.

The Nanjing-Changzhou section of the Shanghai-Nanjing Expressway from Nanjing to Shanghai in Jiangsu Province was chosen as an experimental region, 7 toll stations of the expressway were chosen, as shown in FIG. 3, and an expressway network map was created.

$${A}_{uv} = [ \begin{matrix}0 & 0 & 1 & 0 & 0 & 0 & 0 \\ 0 & 0 & 1 & 1 & 0 & 0 & 0 \\ 1 & 1 & 0 & 0 & 0 & 0 & 0 \\ 0 & 1 & 0 & 0 & 0 & 1 & 0 \\ 0 & 0 & 0 & 0 & 0 & 1 & 1 \\ 0 & 0 & 0 & 1 & 1 & 0 & 0 \\ 0 & 0 & 0 & 0 & 1 & 0 & 0\end{matrix} ]$$

The experiment of the present invention was established based on different time steps through many experiments. The present invention obtained an optimal simulation parameter: t=130 by comparing simulation data with actual observation data. For comparison, the present invention also calculates classical random walk (RW) with restart probability r=0.5 on the same graph as a reference. FIG. 4 shows the comparison between observed traffic data and simulation data of RW and quantum random walk.

In FIG. 4, the present invention can observe that quantum random walk simulation is neither purely random nor regularly periodic. It is more like quasi-periodic oscillation. Because of the large daily period in the observation data, both quantum random walks cannot capture some low traffic flows well. However, the overall structure of irregular peak distribution is similar to the peak distribution of quantum random walks. Compared with random peak distribution generated by RW, the time correspondence between observation data and quantum random walks is much better. Because of individual interaction and superposition appearing in quantum random walks, the combination probability of two random processes is not equal to the simple addition of their probabilities. Instead, it is the vector addition of probability amplitudes.

Under the assumption of quantum random walks, the interference of waves makes the peak value of combination probability higher than the peak value of addition probability. It is highly consistent with the following assumption: the interaction of drivers will follow vehicles in a wave propagation manner.

Table 1 provides the measures of dissimilarity between RW and quantum random walk simulation. In most stations, except N4 and N6, the performance of quantum random walks was better than RW simulation. If the present invention found dissimilar distances, it indicated similarity in different time scales, and under different smoothing factors, most stations showed that the dissimilarity between observation data and quantum random walk simulation data was significantly reduced, but the simulation of these reductions was not clearly detected in random walks. This means that quantum random walk simulation can capture the long-term time variation of expressway traffic.

TABLE 1
Table of Comparison Between Observation Data
and Simulation Data in Different Time Scales

| Station | Model | K = 2 | K = 4 | K = 6 | K = 12 | K = 24 | K = 48 |
|---|---|---|---|---|---|---|---|
| n1 | QRW | 3128 | 2676 | 2253 | 1239 | 299 | 14 |
| | RW | 3637 | 3635 | 3633 | 3627 | 3616 | 3593 |
| n2 | QRW | 391 | 389 | 388 | 384 | 377 | 362 |
| | RW | 748 | 769 | 789 | 849 | 963 | 1154 |
| n3 | QRW | 387 | 326 | 269 | 137 | 28 | 1 |
| | RW | 568 | 571 | 574 | 582 | 599 | 633 |
| N4 | QRW | 1028 | 1149 | 1261 | 1521 | 1745 | 1803 |
| | RW | 902 | 913 | 925 | 958 | 1025 | 1153 |
| N5 | QRW | 410 | 420 | 429 | 459 | 515 | 613 |
| | RW | 608 | 599 | 590 | 564 | 511 | 410 |
| N6 | QRW | 917 | 1026 | 1127 | 1361 | 1555 | 1604 |
| | RW | 902 | 941 | 980 | 1094 | 1295 | 1554 |
| N7 | QRW | 471 | 408 | 349 | 202 | 55 | 3 |
| | RW | 464 | 437 | 410 | 332 | 203 | 62 |

1. A quantum computing method for expressway traffic flow distribution simulation considering destination selection, comprising the following steps:
(1) constructing an expressway exit and entrance network structure;
(2) using a complex number to represent direction-and-flow superposition states of vehicles;
(3) constructing a model and setting parameters;
(4) simulating a quantum random walk;
(5) performing model check and time-space matching; and
(6) fitting and comparing the quantum random walk with real flow data.

2. The quantum computing method for expressway traffic flow distribution simulation considering destination selection according to claim 1, wherein constructing an expressway exit and entrance network structure in step (1) comprises: an unweighted, undirected and acyclic network graph G=(V, E( )) is created according to the connecting relation between an expressway network and stations extracted from expressway network data to be simulated, wherein V represents a vertex set of G, E represents an edge set of G; and an adjacency matrix of the network graph and its eigenvalues, eigenvectors and eigenprojections are calculated.

3. The quantum computing method for expressway traffic flow distribution simulation considering destination selection according to claim 1, wherein using a complex number to represent direction-and-flow superposition states of vehicles in step (2) comprises: a quantum model is used to make each vehicle in a superposition state of simultaneously existing from each exit; dynamic probabilities are used to characterize and explain such a superposition state; a mapping parameter between the model in the present invention and actual situation is calculated according to walk time and the eigenvalues of the network graph; and a probability amplitude matrix for each vertex, i.e., a wave function, is obtained based on the mapping parameter and combining with the eigenprojections.

4. The quantum computing method for expressway traffic flow distribution simulation considering destination selection according to claim 1, wherein constructing a model and setting parameters in step (3) comprises: assuming that a walker is in a state |ν [symbol] at the initial time, the continuous quantum walk state of the walker on G is a linear superposition state for all ground states at any time tin quantum mechanics, i.e.,
$$\vert φ ( t ) 〉 = {\sum }_{v ∈ V} {α}_{v} ( t ) \vert v 〉$$
wherein v is a vertex, V is a vertex set of G, α_{ν}(t) is a probability amplitude of a corresponding ground state |ν [symbol] at a time t, and |α_{ν}(t)|ϵ[0,1]; and the probability of the random walker in a ground state |ν [symbol] at a time t is p(|ν [symbol] , t)=α_{ν}(t)α*_{ν}(t), wherein α*_{ν}(t) is a complex conjugate of α_{ν}(t), and at any time t, Σ_{νϵV}p(|ν [symbol] , t), t)=1 is met;
the state of the walker after time t can be obtained by the following equation:

|φ(t) [symbol] =e^{-iAt}|ν [symbol]
wherein e^{-iAt} is a computing operator of an adjacency matrix A;
the probability p_{νu}(t) of the walker walking from the vertex v to the vertex u after time t is:
p_{νu}(t)=|u|φ(t) [symbol] |².

5. The quantum computing method for expressway traffic flow distribution simulation considering destination selection according to claim 1, wherein simulating a quantum random walk in step (4) comprises: a simulation experiment is carried out based on the quantum random walk model, and is compared with actual direction-and-flow data of walkers on the expressway to continuously optimize the initial state and walk time of the walkers.

6. The quantum computing method for expressway traffic flow distribution simulation considering destination selection according to claim 1, wherein performing model check and time-space matching in step (5) comprises: an exhaustive search mechanism is used to change the parameter t at a certain interval Δt and find an optimal model parameter; when a certain parameter t is reached with observation data and simulation data having the highest similarity/lowest dissimilarity, there are obvious energy resonances in different time scales, the parameter is regarded as an optimal parameter for such transportation systems.
